(19) United States
(12) Patent Application Publication
(10) Pub. No.: US 2019/0294736 A1
(43) Pub. Date: Sep. 26, 2019

(54) SPEAKER GRILL RIB PATTERN GENERATOR

(71) Applicant: Ford Motor Company, Dearborn, MI (US)

(72) Inventor: Eric Bowman, Livonia, MI (US)

(73) Assignee: Ford Motor Company, Dearborn, MI (US)

(21) Appl. No.: 15/928,617

(22) Filed: Mar. 22, 2018

(51) Int. Cl. G06F 17/50; H04R 1/02

(52) U.S. Cl. CPC G06F 17/50; H04R 1/023

(57) ABSTRACT

A computer includes a memory and a processor programmed to execute instructions stored in the memory. The instructions include triangulating a plurality of holes in a speaker grill and generating a Voronoi-based rib pattern as a result of triangulating the plurality of holes. Each line of the Voronoi-based rib pattern is centered between at least two of the plurality of holes within a predetermined threshold.

### BACKGROUND

A speaker is an electromechanical device that produces sound. Some speakers have a speaker grill, which is a screen that protects the internal components of a speaker. A speaker grill has an A-side, which is the side that is visible to a consumer during normal operation of the speaker, and a B-side, which is the side facing the inside of the speaker. Both the A-side and B-side of the speaker grill have holes.

### BRIEF DESCRIPTION OF THE DRAWINGS

FIG. 1 illustrates an example computer for designing speaker grill rib patterns.

FIGS. 2A-2D illustrate various stages in the speaker grill rib pattern design.

FIG. 3 is a flowchart of an example process that may be executed by the computer.

### DETAILED DESCRIPTION

Ribs can be used on the B-side of the speaker grill to structurally support the speaker grill. Designing a rib pattern is extremely complex, however. For example, while the holes of each side of the speaker grill are aligned with one another, the holes on the A-side do not necessarily have the same configuration as the holes on the B-side. The holes on each side may be tapered differently even though the centers of the holes are otherwise aligned. As a result, the distance between the edges of the holes on the A-side may be different from the distance between the edges of the holes on the B-side. Moreover, the thickness of each rib segment may extend partially into the B-side holes. The design constraints, however, may prevent the rib segments from blocking the A-side holes. Otherwise, the ribs would be visible through the A-side holes and may also interfere with the speaker sound. Segments that are off by more than a small amount, e.g., on the order of a tenth of a millimeter, can cause the speaker grill to fail certain design specifications.

Manually designing rib patterns is tedious. A speaker grill can have thousands of B-side holes, and it can take a human designer weeks, if not months, to manually design a rib pattern on a speaker grill given the complexities of the design constraints and the little room for error. A person designing a rib pattern might circle a group of B-side holes and begin drawing lines around each of the holes in the group. If one of the lines cannot be centered in a way that meets the design criteria (i.e., the line cannot fall within 0.1 mm of two holes), the designer selects a new set of holes. This manual process is repeated for several weeks, or possibly longer, until a satisfactory set of rib locations can be determined.

The computer described below creates rib patterns based on Voronoi diagrams using a particular set of rules that are different from how a human would design speaker grill rib patterns. The operations performed by the computer are different from how a human designer would design rib patterns at least because the operations rely on data (e.g., centers of mass, triangulations, etc.) not considered by human speaker grill designers. Further, the operations performed by the computer result in centering of the speaker grill rib segments more accurately than through human-based designs. Thus, the operations of the computer result in a final speaker grill rib pattern design faster than manually designed rib patterns since it avoids much of the iterative process involved in human-generated designs.

An example computer includes a memory a processor programmed to execute instructions stored in the memory. The instructions include triangulating a plurality of holes in a speaker grill and generating a Voronoi-based rib pattern as a result of triangulating the plurality of holes. Each line of the Voronoi-based rib pattern is centered between at least two of the plurality of holes within a predetermined threshold.

Generating the Voronoi-based rib pattern may include performing a Delauney triangulation of a plurality of hole centers of mass to identify a plurality of triangles. Generating the Voronoi-based rib pattern may further include identifying a circumcenter of each of the plurality of triangles. Generating the Voronoi-based rib pattern may further include connecting the circumcenters of adjacent triangles using straight line segments.

The instructions may further include determining the locations of the plurality of holes on a B-side of the speaker grill. Determining the locations of the plurality of holes on the B-side of the speaker grill may include receiving an image or computer model of the B-side of the speaker grill and determining the locations of the plurality of holes on the B-side of the speaker grill from the image or computer model. Alternatively, determining the locations of the plurality of holes on the B-side of the speaker grill may include receiving an image or computer model of the A-side of the speaker grill and determining the locations of the plurality of holes on the B-side of the speaker grill from the image or computer model.

An example method includes triangulating a plurality of holes in a speaker grill and generating a Voronoi-based rib pattern as a result of triangulating the plurality of holes. Each line of the Voronoi-based rib pattern is centered between at least two of the plurality of holes within a predetermined threshold.

Generating the Voronoi-based rib pattern may include performing a Delauney triangulation of a plurality of hole centers of mass to identify a plurality of triangles. Generating the Voronoi-based rib pattern may further include identifying a circumcenter of each of the plurality of triangles. Generating the Voronoi-based rib pattern may further include connecting the circumcenters of adjacent triangles using straight line segments.

The method may further include determining the locations of the plurality of holes on a B-side of the speaker grill. Determining the locations of the plurality of holes on the B-side of the speaker grill may include receiving an image or computer model of the B-side of the speaker grill and determining the locations of the plurality of holes on the B-side of the speaker grill from the image or computer model. Alternatively, determining the locations of the plurality of holes on the B-side of the speaker grill may include receiving an image or computer model of the A-side of the speaker grill and determining the locations of the plurality of holes on the B-side of the speaker grill from the image or computer model.

Triangulating the plurality of holes may include identifying a center of mass of each of the plurality of holes and connecting the center of mass of one of the plurality of holes to the centers of mass of the other plurality of holes with virtual line segments.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

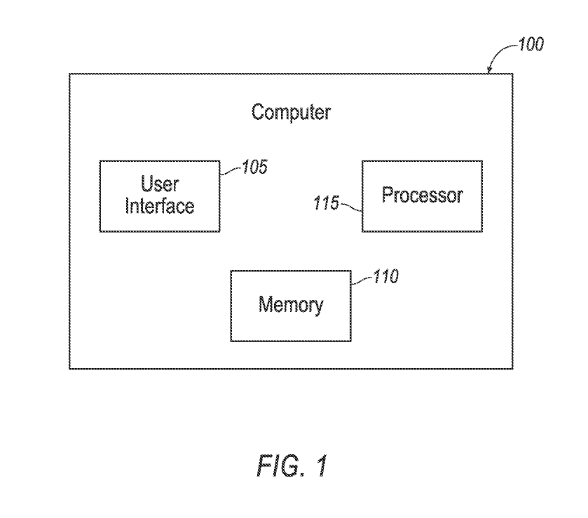

As illustrated in FIG. 1, a computer 100 for designing speaker grill rib patterns includes a user interface 105, a memory 110, and a processor 115.

The user interface 105 is implemented via circuits, chips, or other electronic components that can receive user inputs, present visual representations of data, or both. Examples of user interfaces 105 may include a mouse, keyboard, touchpad, touch screen, display screen (such as a computer monitor), or the like. One or more components of the user interface 105 are programmed to receive user inputs, from a user of the computer 100, and convert the user inputs into electrical signals that can be processed by the processor 115. Further, one or more components of the user interface 105 are programmed to receive signals output by the processor 115 and display visual representations of data represented by the signals output by the processor 115.

The memory 110 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory 110 may store instructions executable by the processor 115 and data such as images uploaded to the computer 100, data concerning the locations of holes on the A- and B-sides of a speaker grill, images generated by the processor 115, etc. The instructions and data stored in the memory 110 may be accessible to the processor 115 and possibly other components of the computer 100.

The processor 115 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The processor 115 can execute instructions stored in the memory 110, receive the data stored in the memory 110, process the data stored in the memory 110, receive user inputs via the components of the user interface 105, and output data to the user interface 105 for presentation to a user of the computer 100. As explained in greater detail below, the processor 115 is programmed to generate speaker grill rib patterns with ribs that are centered, within 0.1 mm accuracy, between the holes on the B-side of the speaker grill.

The processor 115 may be programmed to execute instructions stored in the memory 110 to generate the speaker grill rib patterns. The processor 115 may be programmed to receive a user input that identifies the locations of the holes on the A-side of the speaker grill. The user input identifying the locations of the holes on the A-side of the speaker grill may be in the form of an image or computer-aided design (CAD) model representing the A-side of the speaker grill, in which case the processor 115 is programmed to process the image or CAD model to determine the locations of the holes on the A-side of the speaker grill. The processor 115 is programmed to determine the locations of the holes on the B-side of the speaker grill. The locations of the holes on the B-side of the speaker grill may be based on the locations of the holes on the A-side of the speaker grill or by processing an image or CAD model representing the B-side of the speaker grill. In some instances, the processor 115 may determine the locations of the holes on the A-side of the speaker grill, the B-side of the speaker grill, or both, at shutoff (i.e., from an area between the A-side and B-side of the speaker grill).

The processor 115 is programmed to triangulate the centers of mass of various holes on the B-side of the speaker grill. The processor 115 may be programmed to perform a triangulation technique such as Delauney triangulation connecting the centers of masses of various holes. The lines connecting the centers of the holes form virtual triangles with endpoints. The processor 115 is further programmed to generate a Voronoi-based rib pattern from the triangulation performed. To generate the Voronoi-based rib pattern, the processor 115 is programmed to virtually draw, for each virtual triangle resulting from the Delauney triangulation, a virtual circle that touches each corner of one of the triangles. The processor 115 draws one virtual circle for each virtual triangle. To complete the Voronoi-based rib pattern, the processor 115 identifies the center of each virtual circle and connects the center of each of the virtual circles to the center of two other virtual circles using straight lines. In some instances, the centers of each virtual circle are connected to the closest centers of other virtual circles. Put another way, generating the Voronoi-based rib pattern may include performing a Delauney triangulation of a plurality of hole centers of mass to identify a plurality of triangles, identifying a circumcenter of each of the plurality of triangles, and connecting the circumcenters of adjacent triangles using straight line segments. The resulting pattern formed by the straight lines connecting the centers of each of the centers of the virtual circles is the Voronoi-based rib pattern. The resulting pattern also forms the Voronoi-based rib pattern because, e.g., the lines in the resulting pattern are centered between the holes on the B-side of the speaker grill with little deviation (i.e., less than a predetermined threshold of 0.1 mm off center). The processor 115 may be programmed to output the Voronoi-based rib pattern via the user interface 105 and receive user inputs, via the user interface 105, that allow the user to either confirm the rib pattern or modify the rib pattern, although some modifications may cause the processor 115 to generate a different Voronoi-based rib pattern for at least some sections of the speaker grill.

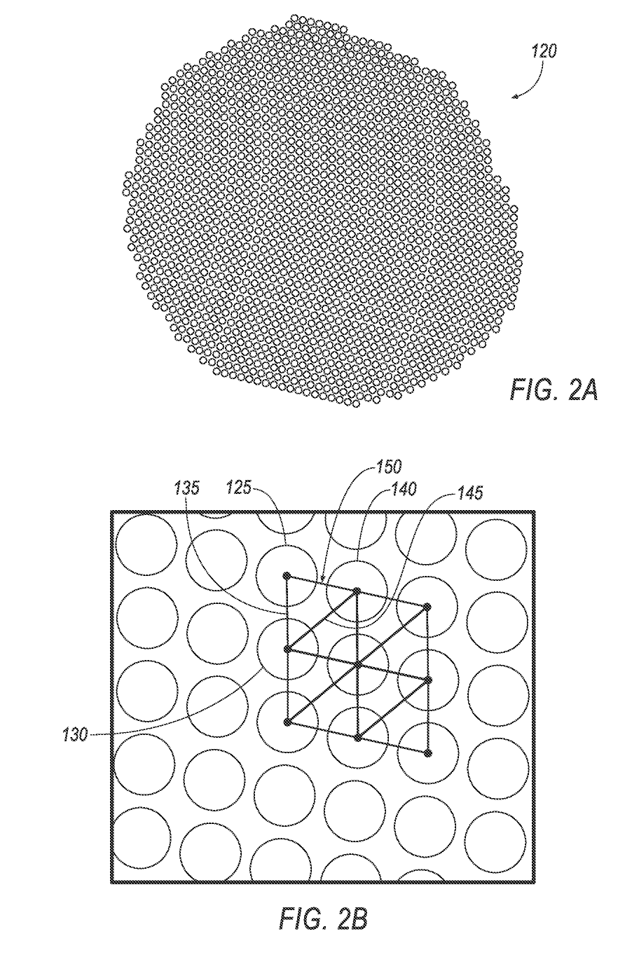

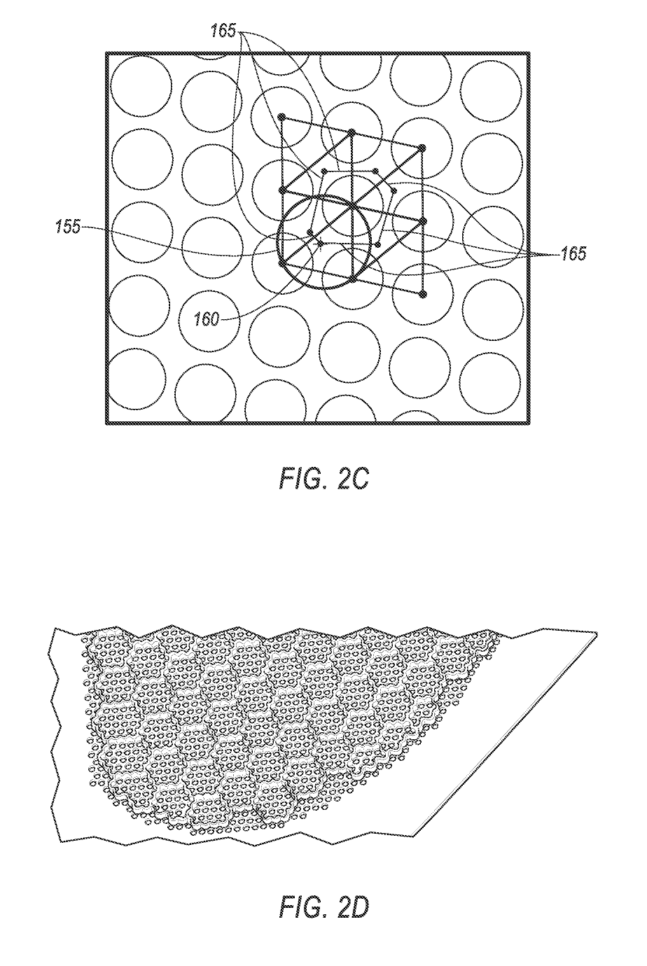

FIGS. 2A-2D illustrate how the Voronoi-based rib pattern is generated. As shown in FIG. 2A, the processor 115 receives an image or CAD model 120 showing the locations of the B-side of the speaker grill. The processor 115 may process the image or CAD model 120 representing the B-side of the speaker grill to determine the locations of the holes on the B-side of the speaker grill.

Referring now to FIG. 2B, the processor 115 triangulates the centers of mass of groups of holes on the B-side of the speaker grill. The processor 115 may be programmed to identify the centers of mass and perform a triangulation technique such as Delauney triangulation connecting the centers of masses of various holes to generate various triangles. Performing the Delauney triangulation may include selecting the centers of adjacent holes (referred to as a “first hole 125” and a “second hole 130”), connecting the centers of the first hole 125 and the second hole 130 with a first line segment 135, selecting the center of a third hole 140 adjacent to the first hole 125 and the second hole 130, connecting the center of the second hole 130 to the third hole 140 with a second line segment 145, and connecting the center of the third hole 140 to the first hole 125 with a third line segment. The line segments connecting the centers of the holes form virtual triangles 150 with endpoints.

As shown in FIG. 2C, the processor 115 generates a Voronoi-based rib pattern, around each hole, from the triangulation performed. To generate the Voronoi-based rib pattern, the processor 115 virtually draws, for each virtual triangle 150 resulting from the Delauney triangulation, a virtual circle 155 that touches each corner of one of the triangles 150, resulting in one virtual circle 155 for each virtual triangle 150. To complete the Voronoi-based rib pattern, the processor 115 identifies the center 160 of each virtual circle 155 (i.e., the circumcenter of the corresponding triangle) and connects the center 160 of each of the virtual circles 155 to the center 160 of other virtual circles 155 of adjacent triangles using straight line segments 165. In some instances, the centers 160 of each virtual circle 155 are connected to the closest centers 160 of other virtual circles 155. While each center 160 of FIG. 2C is shown connected to only two other centers, 160, it is possible that each center 160 would be connected to three other centers 160 (e.g., one center 160 for each side of the triangle). The resulting pattern formed by the straight line segments 165 connecting the centers 160 of each of the virtual circles 155 forms the basis of the Voronoi-based rib pattern shown in FIG. 2D. As previously discussed, the resulting pattern (i.e., the group of lines 165) also can form the Voronoi-based rib pattern because, e.g., the lines in the resulting pattern are centered between the holes on the B-side of the speaker grill with little deviation (i.e., less than a predetermined threshold of 0.1 mm off center).

FIG. 2D illustrates an example model 120 of a speaker grill 175 where the processor 115 has determined the rib pattern 170 for all holes based on the lines 165 shown in and discussed with respect to FIG. 2C. The processor 115 may virtually connect various line segments 165 to generate the rib pattern 170 shown in FIG. 2D. The model 120 of the speaker grill 175 with the Voronoi-based rib pattern 170 shown in FIG. 2D may be presented via the user interface 105 so, e.g., the user has an opportunity to review and modify the rib pattern 170. That is, by making user inputs to the user interface 105, the user can manually select different lines 165 from which to form the Voronoi-based rib pattern 170.

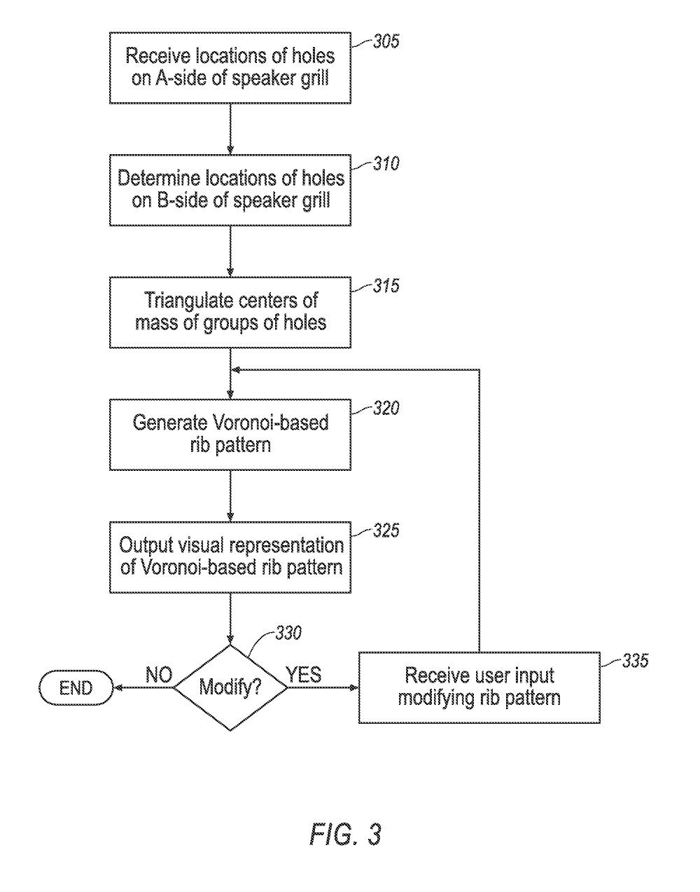

FIG. 3 is a flowchart of an example process 300 that may be implemented by the computer 100 to generate Voronoi-based speaker grill rib patterns.

At block 305, the computer 100 receives a user input that identifies the locations of the holes on the A-side of the speaker grill. The user input may be received via the user interface 105 and provided to the processor 115 for processing. The user input identifying the locations of the holes on the A-side of the speaker grill may be in the form of an image or CAD model 120 representing the A-side of the speaker grill, in which case the processor 115 is programmed to process the image or CAD model 120 to determine the locations of the holes on the A-side of the speaker grill.

At block 310, the computer 100 determines the locations of the holes on the B-side of the speaker grill. The processor 115 may determine the locations of the holes on the B-side of the speaker grill from the locations of the holes on the A-side of the speaker grill or by processing an image or CAD model 120 representing the B-side of the speaker grill. Thus, determining the locations of the holes on the B-side of the speaker grill may include the processor 115 processing the image or CAD model 120 representing the A-side of the speaker grill (at block 305) and determining the locations of the holes on the B-side of the speaker grill in accordance with the locations of the holes on the A-side of the speaker grill. Alternatively, determining the locations of the holes on the B-side of the speaker grill may include the processor 115 receiving an image or CAD model 120 representing the locations of the holes on the B-side of the speaker grill and processing that image or CAD model 120. In some instances, the CAD model 120 may include the locations of the holes of both the A-side and B-side of the speaker grill. Thus, the processor 115 may process the same CAD model 120 to determine the locations of the holes on both the A-side and B-side of the speaker grill.

At block 315, the computer 100 triangulates the centers of mass of groups of holes on the B-side of the speaker grill. The processor 115 may identify the centers of mass of each hole in the group and perform a triangulation technique such as Delauney triangulation connecting the centers of masses of the holes in the group to form virtual triangles 150 with endpoints. An example of how the processor 115 performs the Delauney triangulation technique is described above with respect to FIG. 2B. Put another way, generating the Voronoi-based rib pattern may include performing Delauney triangulation of a plurality of hole centers of mass to identify a plurality of triangles.

At block 320, the computer 100 generates a Voronoi-based rib pattern. As discussed above with respect to FIG. 2C, to generate the Voronoi-based rib pattern, the processor 115 is programmed to virtually draw, for each virtual triangle 150 resulting from the Delauney triangulation, a virtual circle 155 that touches each corner of one of the triangles 150. The processor 115 draws one virtual circle 155 for each virtual triangle 150. To complete the Voronoi-based rib pattern, the processor 115 identifies the center 160 of each virtual circle 155 (i.e., a circumcenter of each of the plurality of triangles) and connects the center 160 of each of the virtual circles 155 to the center 160 of other virtual circles 155 of adjacent triangles using straight lines. In some instances, the centers 160 of each virtual circle 155 are connected to the two closest centers 160 of other virtual circles 155, and no center 160 is connected to more than two other centers 160. The rib pattern 170 is formed by grouping various straight lines 165 (some of which may be associated with different holes) connecting the centers 160 of each of the virtual circles 155. The lines 165 in the rib pattern 170 are centered between adjacent holes on the B-side of the speaker grill with little deviation (i.e., less than a predetermined threshold of 0.1 mm off center).

At block 325, the computer 100 outputs a visual representation of the Voronoi-based rib pattern. That is, the processor 115 may command the user interface 105 to display the visual representation of the Voronoi-based rib pattern generated at block 320.

At decision block 330, the computer 100 prompts the user to select whether to modify the Voronoi-based rib pattern. The processor 115 may process any resulting user input that indicates the user's desire to modify the Voronoi-based rib pattern 170 generated at block 320. If the user wishes to modify the Voronoi-based rib pattern 170, the process 300 may proceed to block 335. If the user does not wish to modify the Voronoi-based rib pattern 170, the processor 115 may determine that the user has confirmed the Voronoi-based rib pattern 170, and the process 300 may end.

At block 335, the computer 100 receives a user input modifying the Voronoi-based rib pattern 170. For example, the user input may adjust the location of one or more of the lines 165 forming the Voronoi-based rib pattern 170. Alternatively or in addition, the user input may select different lines to include in the rib pattern 170. The user input may be received via the user interface 105. In some instances, the process 300 may return to block 320 after block 335 so the processor 115 can select other lines 165 for inclusion in the rib pattern 170 given the modifications made by the user. In other instances, the process 300 may return to block 330 to allow the user to continue to may make additional manual modifications.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computer comprising:
a memory; and
a processor programmed to execute instructions stored in the memory, the instructions including triangulating a plurality of holes in a speaker grill and generating a Voronoi-based rib pattern as a result of triangulating the plurality of holes, wherein each line of the Voronoi-based rib pattern is centered between at least two of the plurality of holes within a predetermined threshold.

2. The computer of claim 1, wherein generating the Voronoi-based rib pattern includes performing a Delauney triangulation of a plurality of hole centers of mass to identify a plurality of triangles.

3. The computer of claim 2, wherein generating the Voronoi-based rib pattern includes identifying a circumcenter of each of the plurality of triangles.

4. The computer of claim 3, wherein generating the Voronoi-based rib pattern includes connecting the circumcenters of adjacent triangles using straight line segments.

5. The computer of claim 1, the instructions further including determining locations of the plurality of holes on a B-side of the speaker grill.

6. The computer of claim 5, wherein determining the locations of the plurality of holes on the B-side of the speaker grill includes receiving an image or computer model of the B-side of the speaker grill and determining the locations of the plurality of holes on the B-side of the speaker grill from the image or computer model.

7. The computer of claim 5, wherein determining the locations of the plurality of holes on the B-side of the speaker grill includes receiving an image or computer model of the A-side of the speaker grill and determining the locations of the plurality of holes on the B-side of the speaker grill from the image or computer model.

8. A method comprising:
triangulating a plurality of holes in a speaker grill; and
generating a Voronoi-based rib pattern as a result of triangulating the plurality of holes, wherein each line of the Voronoi-based rib pattern is centered between at least two of the plurality of holes within a predetermined threshold.

9. The method of claim 8, wherein generating the Voronoi-based rib pattern includes performing a Delauney triangulation of a plurality of hole centers of mass to identify a plurality of triangles.

10. The method of claim 9, wherein generating the Voronoi-based rib pattern includes identifying a circumcenter of each of the plurality of triangles.

11. The method of claim 10, wherein generating the Voronoi-based rib pattern includes connecting the circumcenters of adjacent triangles using straight line segments.

12. The method of claim 8, further including determining locations of the plurality of holes on a B-side of the speaker grill.

13. The method of claim 12, wherein determining the locations of the plurality of holes on the B-side of the speaker grill includes receiving an image or computer model of the B-side of the speaker grill and determining the locations of the plurality of holes on the B-side of the speaker grill from the image or computer model.

14. The method of claim 12, wherein determining the locations of the plurality of holes on the B-side of the speaker grill includes receiving an image or computer model of the A-side of the speaker grill and determining the locations of the plurality of holes on the B-side of the speaker grill from the image or computer model.
